(19) United States
(12) Patent Application Publication
(10) Pub. No.: US 2016/0171017 A1
(43) Pub. Date: Jun. 16, 2016

(54) MOBILE POSITIONING APPARATUS AND POSITIONING METHOD THEREOF

(71) Applicant: Institute For Information Industry, Taipei (TW)

(72) Inventors: Chih-Hung LI, New Taipei City (TW); Kai-Wei CHIANG, Tainan City (TW); Chen-Kai LIAO, Tainan City (TW); Chien-Hsun CHU, Hsinchu City (TW); Guang-Je TSAI, Wandan Township (TW)

(21) Appl. No.: 14/611,182

(22) Filed: Jan. 31, 2015

(30) Foreign Application Priority Data
Dec. 12, 2014 (CN) 201410765361.5

(51) Int. Cl. G06F 17/30; G06K 9/00

(52) U.S. Cl. CPC G06F 17/30277; G06K 9/00671; G06F 17/30247; G06F 17/30268

(57) ABSTRACT

A mobile positioning apparatus and a positioning method thereof are provided. The mobile positioning apparatus retrieves sensing information and an environment image with environment image featured points. The mobile positioning apparatus determines first location information according to the sensing information, and selects a data image corresponding to the first location information from an image database. The data image has data image featured points which correspond to the environment image featured points. The mobile positioning apparatus determines second location information according to the environment image, the data image, the environment image featured points and the data image featured points, and determines second location information of the mobile positioning apparatus.

### PRIORITY

This application claims priority to Chinese Patent Application No. 201410765361.5 filed on Dec. 12, 2014, which is hereby incorporated by reference in its entirety.

### FIELD

The present invention relates to a mobile positioning apparatus and a positioning method thereof; and more particularly, the mobile positioning apparatus and the positioning method thereof according to the present invention perform an accurate indoor positioning according to the environment conditions.

### BACKGROUND

For conventional indoor positioning technologies, the positioning is completed mostly by means of a single positioning mechanism, for example, by means of infrared rays, wireless signals, inertial measurement, full image comparisons or the like. Specifically, the infrared ray indoor positioning mechanism completes the positioning mainly through deploying infrared ray signal transmitters and receiving infrared ray signals at different positions. However, the accuracy of the infrared ray positioning is limited by such factors as the number of the infrared ray signal transmitters, interferences from the site environment, the weak penetrability of the infrared ray signals or the like.

Similarly, the wireless signal (e.g., such wireless signals as the RFID, the Wi-Fi, the Bluetooth or the like) positioning performs the positioning mainly by detecting the change in range and the signal strength of the wireless signals. However, the accuracy of the wireless signal positioning is also limited by such factors as the additional cost of hardware deployment, the stability of the wireless signals, the environment change, the signal interference or the like.

On the other hand, the inertial measurement performs the positioning mainly by estimating the moving status of an apparatus according to the sensing data (e.g., sensed by an acceleration sensor, a gyroscope sensor or the like) of the apparatus. However, the positioning performed through estimation will cause errors that are quickly accumulated with the time; and in other words, the positioning accuracy will be greatly reduced with the time.

The full image comparison determines the current position of the apparatus by continuously comparing captured images with images in a database. However, this mechanism requires capturing images continuously and comparing each of the images captured with the images in the database, so the computation amount required is relatively huge and the comparison process is relatively time-consuming.

Accordingly, each of the current indoor positioning technologies may have the following drawbacks in use: the additional cost of hardware deployment, the influence of the environment change on the positioning result, the instable positioning accuracy as well as the low positioning efficiency. Accordingly, there is an urgent need in the art to improve the positioning performance and integrate the positioning technologies together so that the positioning can be accomplished more efficiently and more accurately to make improvements on the drawbacks of the conventional technologies.

### SUMMARY

A primary objective of the present invention includes providing a positioning method for a mobile positioning apparatus. The mobile positioning apparatus connects with an image database. The positioning method in certain embodiments comprises: (a) enabling the mobile positioning apparatus to retrieve at least one piece of sensing information and an environment image, wherein the environment image has at least one environment image featured point; (b) enabling the mobile positioning apparatus to determine first location information of the mobile positioning apparatus according to the at least one piece of sensing information; (c) enabling the mobile positioning apparatus to select a data image corresponding to the first location information from the image database, wherein the data image has at least one data image featured point corresponding to the at least one environment image featured point; and (d) enabling the mobile positioning apparatus to determine second location information of the mobile positioning apparatus according to the environment image, the data image, the at least one environment image featured point and the at least one data image featured point.

To achieve the aforesaid objective, certain embodiments of the present invention include a mobile positioning apparatus, which comprises a transceiving unit, a sensing unit, an image retrieving unit and a processing unit. The transceiving unit is configured to connect with an image database. The sensing unit is configured to retrieve at least one piece of sensing information. The image retrieving unit is configured to retrieve an environment image, wherein the environment image has at least one environment image featured point. The processing unit is configured to determine first location information of the mobile positioning apparatus according to the at least one piece of sensing information; select a data image corresponding to the first location information from the image database via the transceiving unit, wherein the data image has at least one data image featured point corresponding to the at least one environment image featured point; and determine second location information of the mobile positioning apparatus according to the environment image, the data image, the at least one environment image featured point and the at least one data image featured point.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a block diagram of a mobile positioning apparatus according to a first embodiment of the present invention;

FIG. 1B is a schematic view illustrating a process of calculating location information by the mobile positioning apparatus according to the first embodiment of the present invention;

FIG. 2 is a flowchart diagram of a positioning method according to a second embodiment of the present invention; and

FIG. 3 is a flowchart diagram of a positioning method according to a third embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

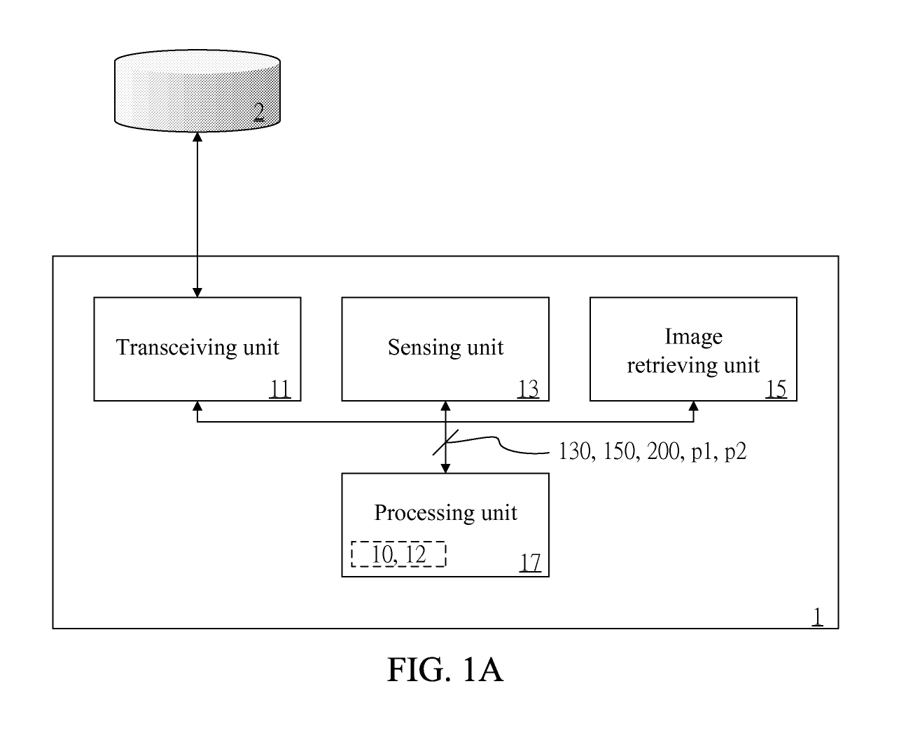

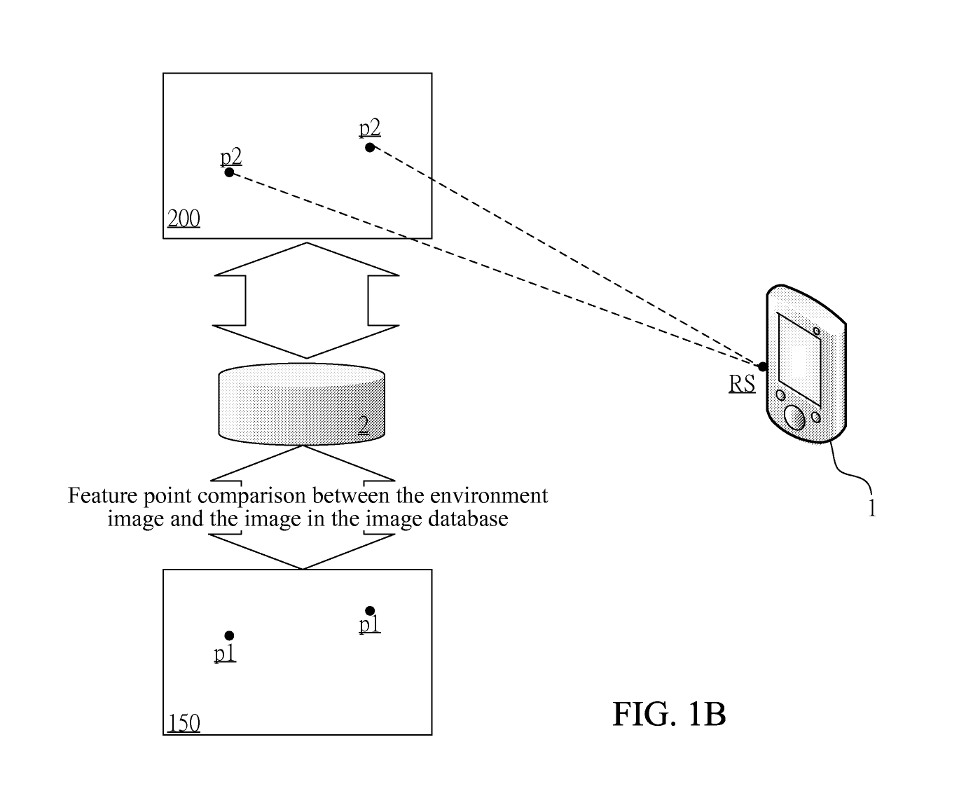

Referring to FIG. 1A, there is shown a block diagram of a mobile positioning apparatus 1 according to a first embodiment of the present invention. The mobile positioning apparatus 1 comprises a transceiving unit 11, a sensing unit 13, an image retrieving unit 15 and a processing unit 17. The transceiving unit 11 connects with an image database 2. It should be particularly appreciated that, the image database 2 has a plurality of images of the indoor environment stored therein in advance, and the information (e.g., relative spatial coordinates, absolute spatial coordinates or the like) related to the indoor position of each of the images is stored at the same time when the image is created; and because the technology to achieve this can be readily understood by those skilled in the art, this will not be further described herein. The positioning process of the present invention will be further described hereinbelow.

Firstly, after entering into an indoor environment, the mobile positioning apparatus 1 mainly performs a preliminary positioning with respect to the environment and then performs position corrections by using images having featured points. Specifically, after entering into the indoor environment, the sensing unit 13 of the mobile positioning apparatus 1 retrieves at least one piece of sensing information 130. At the same time, the image retrieving unit 15 retrieves an environment image 150. The environment image 150 has at least one environment image featured point p1. It should be particularly appreciated that, in the first embodiment, the number of the at least one environment image featured point p1 is two.

Then, the processing unit 17 preliminarily determines first location information 10 of the mobile positioning apparatus 1 according to the at least one piece of sensing information 130. Subsequently, because the image database 2 comprises corresponding indoor image data and location information thereof, the processing unit 17 can select a data image 200 corresponding to the first location information 10 from the image database 2 via the transceiving unit 11. Correspondingly, the data image 200 has at least one data image featured point p2 corresponding to the at least one environment image featured point p1. Similarly, in the first embodiment, the number of the at least one data image featured point p2 is two.

Then, the processing unit 17 can determine second location information 12 of the mobile positioning apparatus 1 according to the real-time environment image 150, the data image 200, the at least one environment image featured point p1 and the corresponding at least one data image featured point p2. The second location information 12 is a piece of more accurate indoor location information.

It should be particularly appreciated that, the aforesaid first location information 10 may be obtained through an Inertial Navigation positioning algorithm. For example, assuming that a user places the mobile positioning apparatus 1 on a car and then carries it from the outdoor to the indoor, then the sensing unit 13 (e.g., an acceleration sensor, a gyroscope, a magnetic sensor, a barometric pressure sensor, a thermal sensor or the like) can sense related inertial sensing information.

Accordingly, the processing unit 17 can determine the inertial usage status of the mobile positioning apparatus 1 on the car according to the at least one piece of sensing information 130 (i.e., the inertial sensing information), and then further determine the first location information 10 of the mobile positioning apparatus 1 based on the Inertial Navigation positioning algorithm.

Similarly, the aforesaid first location information 10 may also be obtained through a Pedestrian Dead Reckoning positioning algorithm. For example, assuming that the user places a mobile phone on his or her body, then the sensing unit 13 (e.g., an acceleration sensor, a gyroscope, a magnetic sensor, a barometric pressure sensor, a thermal sensor or the like) can sense related user action sensing information.

Accordingly, the processing unit 17 can determine that the mobile positioning apparatus 1 is currently placed on the user according to the at least one piece of sensing information 130 (i.e., the user action sensing information), and further determine the first location information 10 of the mobile positioning apparatus 1 based on the Pedestrian Dead Reckoning positioning algorithm.

On the other hand, referring to FIG. 1B together, there is shown a schematic view illustrating a process of calculating the second location information 12 by the mobile positioning apparatus 1 according to the first embodiment of the present invention, where the second location information 12 can be obtained mainly in the resection calculating manner. Specifically, after having obtained the environment image 150, the data image 200, the at least one environment image featured point p1 and the at least one data image featured point p2, the processing unit 17 can calculate a resection point RS relative to the data image 200 according to the calculating principle of the resection and by using formulas

$${x}_{a} = {x}_{p} - c \frac{{m}_{11} ( {X}_{A} - {X}_{0} ) + {m}_{12} ( {Y}_{A} - {Y}_{0} ) + {m}_{13} ( {Z}_{A} - {Z}_{0} )}{{m}_{31} ( {X}_{A} - {X}_{0} ) + {m}_{32} ( {Y}_{A} - {Y}_{0} ) + {m}_{33} ( {Z}_{A} - {Z}_{0} )} + Δ x$$

and

$${y}_{a} = {y}_{p} - c \frac{{m}_{21} ( {X}_{A} - {X}_{0} ) + {m}_{22} ( {Y}_{A} - {Y}_{0} ) + {m}_{23} ( {Z}_{A} - {Z}_{0} )}{{m}_{31} ( {X}_{A} - {X}_{0} ) + {m}_{32} ( {Y}_{A} - {Y}_{0} ) + {m}_{33} ( {Z}_{A} - {Z}_{0} )} + Δ y .$$

Here, the resection point RS is just the location of the mobile positioning apparatus 1 (i.e., the second location information 12).

Further speaking, the coordinates xₚ and yₚ of the principal point of the image, the three-dimensional rotation matrix m (as well as a rotation angle contained therein), the focal distance c, and the lens distortion correction parameters Δx and Δy in the aforesaid formulas are all parameters of the image retrieving unit 15 that are fixed as default setting, and the actual coordinates X_{A}, Y_{A}, and Z_{A} of the featured point in space may also be recorded at the same time when the data image is created. Accordingly, the position X₀, Y₀, and Z₀ of the image retrieving unit 15 (i.e., the position of the mobile positioning apparatus 1) can be obtained through calculation by using the parameters of only two featured points xₐ, yₐ.

In detail, the aforesaid position coordinates X₀, Y₀, and Z₀ of the image retrieving unit 15 are three unknown numbers, so the solutions thereof shall be obtained through at least three equations. However, when the image has coordinates of two different featured points, four equations can be obtained by substituting the coordinates into the aforesaid formulas. Thus, the solutions of the three unknown numbers X₀, Y₀, and Z₀ can be obtained. It should be particularly appreciated that, if the aforesaid parameters of the image retrieving unit 15 that are fixed before shipment can not be directly obtained, then the user may also directly use self-defined parameters that have similar numerical values because values of the parameters of image retrieving units from different manufacturers have small differences therebetween, or the user may directly calibrate the image retrieving unit 15 to acquire related parameters.

However, in other scenarios where the numerical value of one of the three unknown numbers is further obtained by the mobile positioning apparatus 1 through using the sensing unit 13 (e.g., the actual numerical value of Z₀ is acquired by using a barometric pressure sensor), only the numerical values of the other two unknown numbers X₀ and Y₀ remain unknown; and in this case, only two equations are needed to acquire the solutions thereof. For an image that has only a single featured point, the coordinates thereof can be substituted into the aforesaid formulas to obtain two equations, thus directly obtaining the solutions of the two unknown numbers X₀ and Y₀. It should be emphasized that, because how the resection point is calculated through resection can be readily understood by those skilled in the art through the above disclosures of the present invention, this will not be further described herein.

In other implementations, the mobile positioning apparatus 1 may further use related indoor wireless signals to further adjust the positioning information. Specifically, the transceiving unit 11 is further configured to retrieve at least one piece of wireless signal information (not shown), such as a Wi-Fi wireless signal, a Bluetooth wireless signal, an RFID wireless signal or the like. The processing unit 17 then further calculates at least one piece of third location information (not shown) according to the at least one piece of wireless signal information. It should be particularly appreciated that, using wireless signal information for positioning is a well known technology, so it will not be further described herein.

Then, the processing unit 17 calculates fourth location information by using a Kalman filter according to the first location information, the second location information and the at least one piece of third location information. In detail, because the Kalman filter is characterized in using the accuracies of different location information as weight ratio for obtaining optimal solutions through combining and filtering the weight ratio, and contents obtained through different positioning mechanisms can be further integrated through the Kalman filter to obtain more accurate positioning information. Similarly, because how different pieces of location information are adjusted through the Kalman filter can be readily understood by those skilled in the art based on the above disclosures, this will not be further described herein.

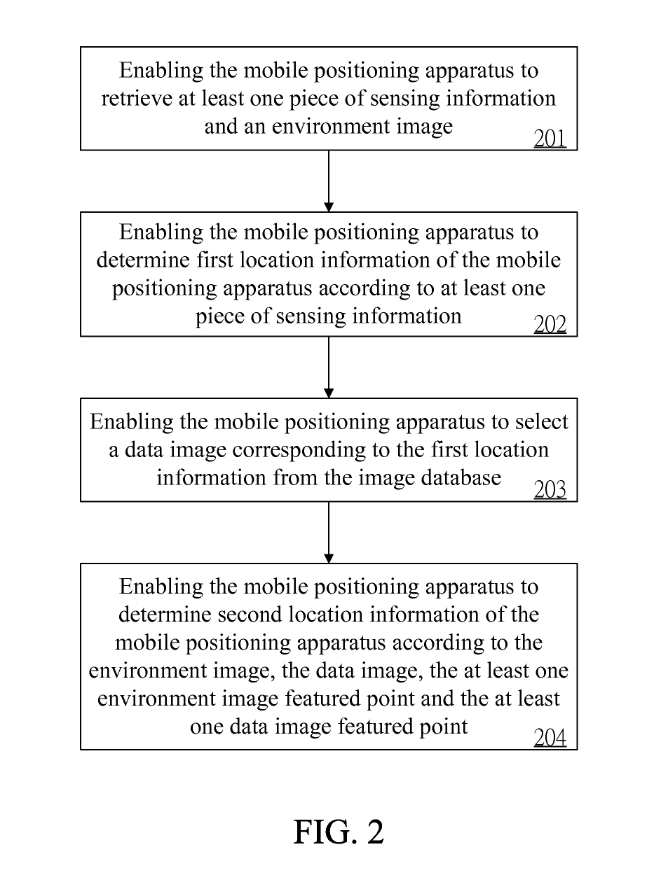

A second embodiment of the present invention is a positioning method, a flowchart diagram of which is shown in FIG. 2. The method of the second embodiment is for use in a mobile positioning apparatus (e.g., the mobile positioning apparatus 1 of the aforesaid embodiment). The mobile positioning apparatus connects with an image database. The detailed steps of the second embodiment are described as follows.

Firstly, a step 201 is executed to enable the mobile positioning apparatus to retrieve at least one piece of sensing information and an environment image. The environment image has at least one environment image featured point. A step 202 is executed to enable the mobile positioning apparatus to determine first location information of the mobile positioning apparatus according to at least one piece of sensing information.

Then, step 203 is executed to enable the mobile positioning apparatus to select a data image corresponding to the first location information from the image database. The data image has at least one data image featured point corresponding to the at least one environment image featured point. Then, step 204 is executed to enable the mobile positioning apparatus to determine second location information of the mobile positioning apparatus according to the environment image, the data image, the at least one environment image featured point and the at least one data image featured point.

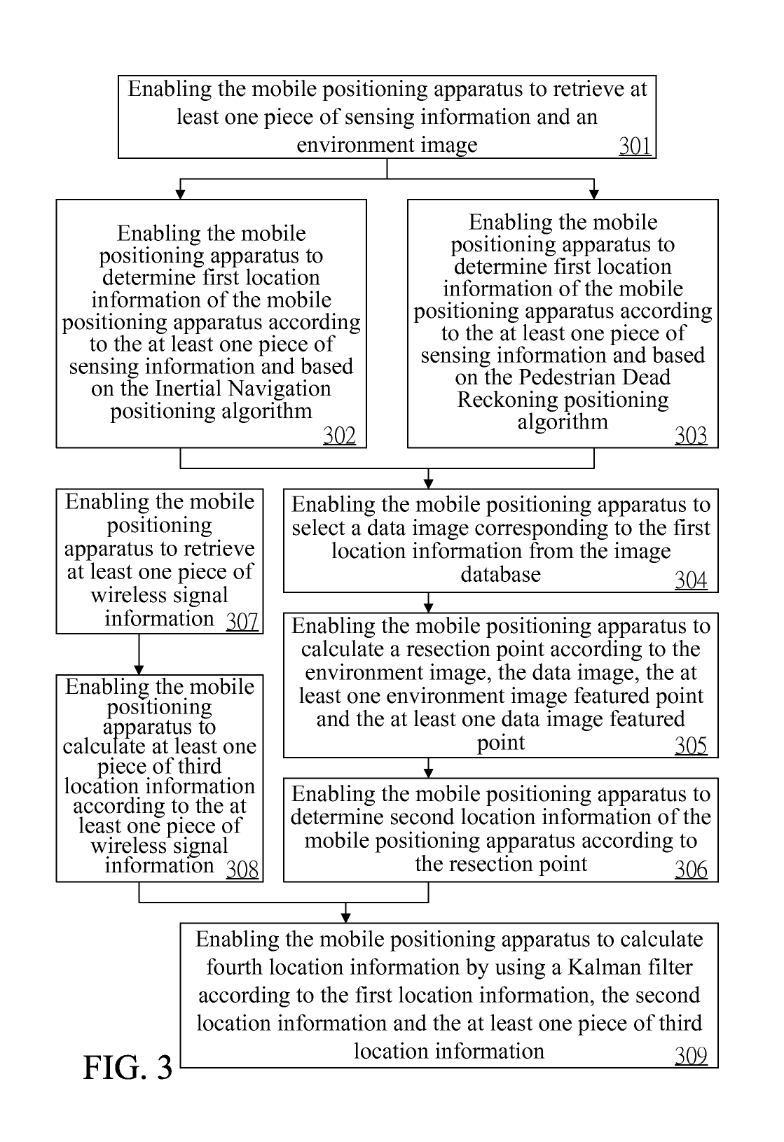

A third embodiment of the present invention is a positioning method, a flowchart diagram of which is shown in FIG. 3. The method of the third embodiment is for use in a mobile positioning apparatus (e.g., the mobile positioning apparatus 1 of the aforesaid embodiment). The mobile positioning apparatus connects with an image database. The steps of the third embodiment are detailed as follows.

Firstly, step 301 is executed to enable the mobile positioning apparatus to retrieve at least one piece of sensing information and an environment image. The environment image has at least one environment image featured point. Then, the location information can be achieved by executing step 302 or step 303 according to the information detected by a sensor. If it is determined from the sensing information that Inertial Navigation needs to be performed, then the step 302 is executed to enable the mobile positioning apparatus to determine first location information of the mobile positioning apparatus according to the at least one piece of sensing information and based on the Inertial Navigation positioning algorithm.

On the other hand, if it is determined from the sensing information that Pedestrian Dead Reckoning needs to be performed, then the step 303 is executed to enable the mobile positioning apparatus to determine first location information of the mobile positioning apparatus according to the at least one piece of sensing information and based on the Pedestrian Dead Reckoning positioning algorithm. Then, step 304 is executed to enable the mobile positioning apparatus to select a data image corresponding to the first location information from the image database. The data image has at least one data image featured point corresponding to the at least one environment image featured point.

Step 305 is executed to enable the mobile positioning apparatus to calculate a resection point according to the environment image, the data image, the at least one environment image featured point and the at least one data image featured point. Next, step 306 is executed to enable the mobile positioning apparatus to determine second location information of the mobile positioning apparatus according to the resection point.

It should be particularly appreciated that, the positioning method of the third embodiment may further incorporate other positioning mechanisms. Specifically, as shown in the flowchart diagram, step 307 may be additionally executed synchronously to enable the mobile positioning apparatus to retrieve at least one piece of wireless signal information. Then, step 308 is executed to enable the mobile positioning apparatus to calculate at least one piece of third location information according to the at least one piece of wireless signal information. Finally, step 309 is executed to enable the mobile positioning apparatus to calculate fourth location information by using a Kalman filter according to the first location information, the second location information and the at least one piece of third location information.

According to the above descriptions, the mobile positioning apparatus and the positioning method thereof of the present invention can determine a status of the user through use of different pieces of sensing information to estimate a preliminary position of a mobile apparatus by using different algorithms respectively, then position the mobile positioning apparatus more efficiently and more accurately by using the image featured point(s) and through the resection calculation, and further integrate different pieces of positioning information by using a Kalman filter to improve the positioning effect. Thereby, the drawbacks of the prior art can be overcome.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A positioning method for a mobile positioning apparatus, the mobile positioning apparatus connecting with an image database, the positioning method comprising:
(a) retrieving by the mobile positioning apparatus at least one piece of sensing information and an environment image, wherein the environment image has at least one environment image featured point;
(b) determining by the mobile positioning apparatus a first location information of the mobile positioning apparatus according to the at least one piece of sensing information;
(c) selecting by the mobile positioning apparatus a data image corresponding to the first location information from the image database, wherein the data image has at least one data image featured point corresponding to the at least one environment image featured point; and
(d) determining by the mobile positioning apparatus a second location information of the mobile positioning apparatus according to the environment image, the data image, the at least one environment image featured point and the at least one data image featured point.

2. The positioning method of claim 1, wherein the step (b) further comprises:
(b1) determining by the mobile positioning apparatus the first location information of the mobile positioning apparatus according to the at least one piece of sensing information and based on an Inertial Navigation positioning algorithm.

3. The positioning method of claim 1, wherein the step (b) further comprises:
(b1) determining by the mobile positioning apparatus the first location information of the mobile positioning apparatus according to the at least one piece of sensing information and based on a Pedestrian Dead Reckoning positioning algorithm.

4. The positioning method of claim 1, wherein the step (d) further comprises:
(d1) calculating by the mobile positioning apparatus a resection point according to the environment image, the data image, the at least one environment image featured point and the at least one data image featured point; and
(d2) determining by the mobile positioning apparatus the second location information of the mobile positioning apparatus according to the resection point.

5. The positioning method of claim 1, further comprising the following steps before the step (d):
(d1) retrieving by the mobile positioning apparatus at least one piece of wireless signal information; and
(d2) calculating by the mobile positioning apparatus at least one piece of third location information according to the at least one piece of wireless signal information;
wherein the positioning method further comprises the following step after the step (d):
(d3) calculating by the mobile positioning apparatus a fourth location information according to the first location information, the second location information and the at least one piece of third location information by using a Kalman filter.

6. A mobile positioning apparatus, comprising:
a transceiving unit, being configured to connect with an image database;
a sensing unit, being configured to retrieve at least one piece of sensing information;
an image retrieving unit, being configured to retrieve an environment image, wherein the environment image has at least one environment image featured point;
a processing unit, being configured to:
determine first location information of the mobile positioning apparatus according to the at least one piece of sensing information;
select a data image corresponding to the first location information from the image database via the transceiving unit, wherein the data image has at least one data image featured point corresponding to the at least one environment image featured point; and
determine second location information of the mobile positioning apparatus according to the environment image, the data image, the at least one environment image featured point and the at least one data image featured point.

7. The mobile positioning apparatus of claim 6, wherein the processing unit is further configured to determine the first location information of the mobile positioning apparatus according to the at least one piece of sensing information and based on the Inertial Navigation positioning algorithm.

8. The mobile positioning apparatus of claim 6, wherein the processing unit is further configured to determine the first location information of the mobile positioning apparatus according to the at least one piece of sensing information and based on the Pedestrian Dead Reckoning positioning algorithm.

9. The mobile positioning apparatus of claim 6, wherein the processing unit is further configured to:
calculate a resection point according to the environment image, the data image, the at least one environment image featured point and the at least one data image featured point; and
determine the second location information of the mobile positioning apparatus according to the resection point.

10. The mobile positioning apparatus of claim 6, wherein the transceiving unit is further configured to retrieve at least one piece of wireless signal information, and the processing unit is further configured to:
calculate at least one piece of third location information according to the at least one piece of wireless signal information; and
calculate fourth location information according to the first location information, the second location information and the at least one piece of third location information by using a Kalman filter.
